(19) United States
(12) Patent Application Publication
(10) Pub. No.: US 2002/0113912 A1
(43) Pub. Date: Aug. 22, 2002

(54) Dual model near-eye and projection display system

(76) Inventors: Haviland Wright, Boulder, CO (US); Anthony Artigliere, Longmont, CA (US); David C. McDonald, Longmont, CO (US); Mark A. Handschy, Boulder, CO (US); Patrick O'Donnell, Longmont, CO (US)

Correspondence Address: MARSH FISCHMANN & BREYFOGLE, LLP, 3151 S. VAUGHN WAY, SUITE 411, AURORA, CO, 80014, US

(21) Appl. No.: 09/989,976

(22) Filed: Nov. 20, 2001

Related U.S. Application Data
(60) Provisional application No. 60/249,943, filed on Nov. 20, 2000.

(51) Int. Cl. G02F 1/1335

(52) U.S. Cl. 349/13

(57) ABSTRACT

A dual-mode display system, for applications such as viewfinders/displays in a digital still camera or video camcorder, may include a single spatial light modulator microdisplay that can be used both to provide a virtual image at a viewing location, such as near-eye viewing port, and to provide a real image that can be projected onto a surface such as a projection screen. The projection screen may be on an exterior surface of the camera, it may be extendable from the device such as with a camcorder, or it may be an external screen such as a on a wall, desk, piece of paper, or a traditional projection screen. The optical paths for the near-eye and projection modes may be entirely different, with only the SLM in common, or they may be largely or entirely common paths. Different light sources may be used for the two modes, or it may be the same light source. The display system may switch between the two modes by selecting one of two different light sources or by moving an optical element, such as a lens or reflective surface.

This application claims priority from U.S. Provisional Patent Application No. 60/249,943, filed Nov. 20, 2000, the contents of which are incorporated by reference herein.

### FIELD OF THE INVENTION

This invention relates generally to display devices and more specifically to a dual mode display device that can operate in either or both near-eye and projection modes, thus enabling the device to be used as both a personal display and as a shared display

### BACKGROUND OF THE INVENTION

Cameras have traditionally included a viewfinder for the user. Some are as simple as a vignetted port through a camera, with or without simple optics, that enable the user to see the approximate limits of the image to be captured on film. In a single-lens-reflex camera, the port enables the user to view the approximate image to be captured on film by the camera through the actual lens. This improvement enabled a substantial improvement in the quality of personal and professional photography. Of course, the captured image could not be subsequently viewed through the port.

With the advent of digital still cameras, manufacturers initially chose to use small (1.9 inch) electronic displays to allow the user to view the image to be captured and to subsequently playback or view the already-captured images. These electronic displays typically utilized thin-film transistor (TFT) technology. In analyzing the use of products with these displays, manufacturers discovered that they had also enabled a practice by camera users referred to as “group viewing.” Group viewing is the sharing of the image with others nearby in an efficient manner. Such displays have come to be referred to as “shared displays.” One major disadvantage of shared displays has been the great difficulty of reading these displays in sunlight. Another disadvantage is the power consumption by these shared displays. A new family of lower-power near-eye display devices now embedded within cameras overcome the disadvantages of the TFT displays in that they are always usable regardless of ambient lighting conditions, but manufacturers have been reluctant to abandon the newfound group viewing feature. The present invention permits the two features to co-exist in the same device without requiring two separate display devices.

### OVERVIEW OF THE DRAWINGS

FIG. 1 is a plan view of a first embodiment of the present invention in a mode where the near-eye optical path is operative and the projection path is not operative.

FIG. 2 is a plan view of the first embodiment of the invention in a mode where the projection path is operative.

FIG. 3 is a plan view of a second embodiment of the invention in a mode where the near-eye optical path is operative and the projection path is not operative.

FIG. 4 is a plan view of the second embodiment of the invention in a mode where the projection path is operative.

FIG. 5 is a plan view of a third embodiment of the invention showing an alternative projection path layout.

FIG. 6 is a plan view of a fourth embodiment of the invention in which a projected image is shown on an external viewing surface, such as a tabletop or wall.

FIG. 7 is a plan view of the fifth embodiment of the invention in a mode where the near-eye optical path is operative and the projection path is not operative.

FIG. 8 is a plan view of the fifth embodiment of the invention in a mode where the projection path is operative.

FIG. 9 is a plan view of an alternative version of the fifth embodiment of the invention in which a projected image is shown on an external viewing surface, such as a tabletop or wall.

FIG. 10 is a plan view of a sixth embodiment of the invention in a mode where the near-eye optical path is operative and the projection path is not operative.

FIG. 11 is a plan view of a sixth embodiment of the invention in a mode where the near-eye optical path is not operative and the projection path is operative.

FIG. 12 is a plan view of a seventh embodiment of the invention in a mode where the near-eye optical path is operative and the projection path is not operative.

FIG. 13 is a plan view of a seventh embodiment of the invention in a mode where the near-eye optical path is not operative and the projection path is operative.

FIG. 14 is a plan view of an eighth embodiment of the invention showing the positions of optical elements for both near-eye and projection paths.

FIG. 15 is a plan view of a ninth embodiment of the invention in a mode where the near-eye optical path is operative and the projection path is not operative.

FIG. 16 is a plan view of the ninth embodiment of the invention in a mode where the near-eye optical path is not operative and the projection path is operative.

FIG. 17 is a plan view of an alternative version of the ninth embodiment of the invention in a mode where both the near-eye and the projection optical paths may be operative.

FIG. 18 is a plan view of a tenth embodiment of the invention.

FIG. 19 is a side view of an eleventh embodiment of the invention.

FIG. 20 is a plan view of one illumination system that may be used in a number of the embodiments of the invention.

### BRIEF SUMMARY OF THE INVENTION

The present invention is directed to a display device including an image-generating arrangement configured to reproduce images. The images are visible to a viewer when the device is operated in either or both of two image-review modes, including a first mode wherein the device produces a real image of the image-generating arrangement, and a second mode wherein the device produces a virtual image of the image-generating arrangement.

The image-generating arrangement may be a microdisplay. The microdisplay may be a liquid crystal microdisplay, using ferroelectric liquid crystals or nematic liquid crystals. The microdisplay may be a digital micromirror device, a TFT device, or an OLED device. The display device may further include one or more light source arrangements external to the image-generating arrangement that emit light and cooperate with the image-generating arrangement to produce the images during either or both of the modes. At least one of the light source arrangements may include each of a red, a green, and a blue LED. The device may include one and only one light source arrangement. The device may include at least two light source arrangements. The device may further include a light source drive arrangement that establishes the intensity of the light from the one or more light source arrangements. The intensity of the light established by the light source drive arrangement may relate to the image-review mode in which the display device is being operated.

The display device may further include a mode-selection arrangement that establishes the modes in which the display device is being operated. The mode-selection arrangement may include a switch having at least two positions that allows an operator of the device to select the desired image-review mode. The display device may further include an eyepiece in which an operator of the device can look to view the virtual image of the image-generating arrangement when the device is operated in the second mode. The mode-selection arrangement may include a proximity sensor that senses when the operator of the device is looking into the viewfinder. The display device may further include an image screen upon which the real image of the image-generating arrangement appears when the device is operated in the first mode. The image screen may be moveable between at least two positions, an active position for use when the first mode is in operation, and an inactive position for use when the first mode is not in operation. The mode selection arrangement may sense the position of the image screen and accordingly establish the mode in which the device is operated. The display device may further include a sensing arrangement that determines the position of a pointing device in relation to the image screen. The image screen may be polarized to reject at least a portion of the ambient light present in the device's operating environment. The image screen may have non-unity gain.

The virtual image may follow a first optical path to a virtual image location and the real image may follow a second optical path to a real image location. The first optical path and the second optical path may be nowhere coincident. The first and the second optical paths may be substantially coincident. The first and second optical paths may be only partially coincident. At least a portion of the second optical path may be external to the display device. The real image may be formed external to the display device.

The display device may be a digital still camera, a video camera, a portable telecommunication device configured to receive images electronically from an external source, or a personal digital assistant configured to receive images electronically from an external source.

The present invention is also directed to a device for producing images, the device including an illumination arrangement and a reflective spatial light modulator in optical communication with the illumination arrangement, the SLM configured to modulate the light from the illumination arrangement so as to produce images. The device also includes a first lens arrangement that focuses images produced by the SLM such that the focused image appears at a first viewing area, the viewing area being the position of a viewer's retina when the device is operated in a first mode. The device also includes a second lens arrangement that projects images produced by the SLM such that the projected images appear at a second viewing area when the device is operated in a second mode, the second viewing area being visible by more than one viewer.

The present invention also relates to a device for producing images, the device including an image generating arrangement configured such that multiple viewers can simultaneously view the images produced by the device. The improvement includes an arrangement that creates a second image of the image generating arrangement that allows viewing essentially by only one viewer at a time.

The present invention also relates to a display device embedded in an image capture device including a housing containing the image capture device, a microdisplay located in the housing, and a light source located in the housing. A first optical path exists from the light source to a viewing location and a second optical path exists from the light source to a projected image location. Either the first or the second optical path can be selected.

The present invention also relates to a display device embedded in an image capture device that captures images. The display device includes a microdisplay, a first optical arrangement that provides a viewable image of the microdisplay at a near-eye viewing location, and a second optical arrangement that provides a projected image at a projected image location. Either the first optical arrangement or the second optical arrangement can be selected.

The present invention also relates to a method of displaying images captured by an image capture device. The method includes providing a microdisplay, providing an optical path from the microdisplay to a viewing area where an image of the microdisplay can be viewed, and providing an optical path from the microdisplay to a projected image location.

### DESCRIPTION OF THE INVENTION

An invention is herein described for providing a dual-mode display system that allows the user to select either or both of a near-eye (personal display) or a projected view (shared display) mode. One target application for the present invention is a digital still camera, although the invention may be broadly applied to other devices such as camcorders, cellular telephones, game devices, personal viewing devices, personal digital assistants (PDAs), industrial applications, and many more. In the following description, numerous specific details are set forth in order to provide a thorough understanding of the present invention. Based on the following description, however, it will be obvious to one skilled in the art that the present invention may be embodied in a variety of specific configurations. In addition, well-known processes for producing components and certain well-known optical effects of various optical components will not be described in detail in order not to unnecessarily obscure the present invention.

The present invention may be embodied in any number of well-known and yet-to-be-discovered display devices. For example, the present invention currently could be embodied in a digital still camera, a video camera, a personal digital assistant, a cellular telephone, a personal movie player, or a personal gaming device. As new devices are discovered and come into public use, it will be apparent to persons skilled in the art how to adapt the present invention into such devices.

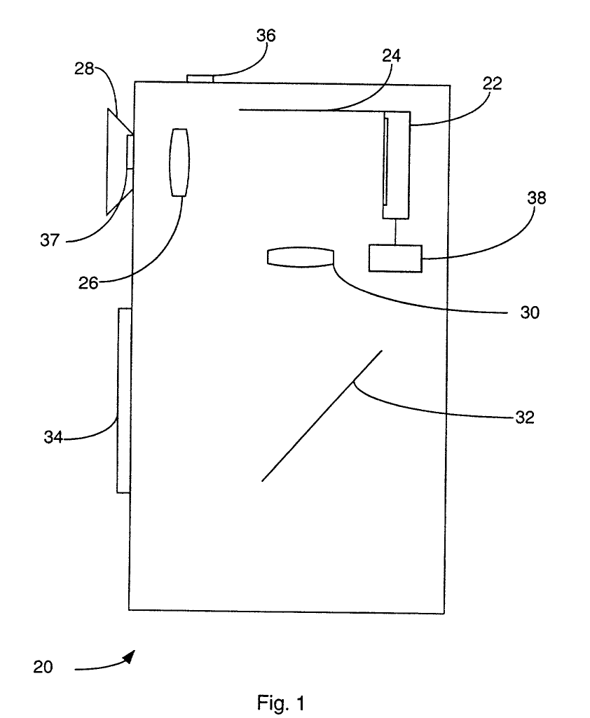

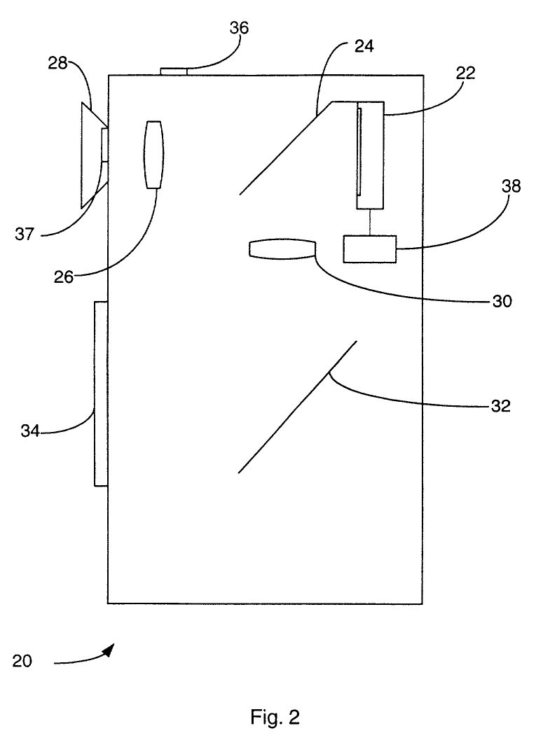

A first embodiment of the invention is presented in FIGS. 1 and 2, which show a display device 20, such as a digital still camera, having an image-generating arrangement 22. In these and other figures, like reference numbers indicate like elements among the figures. As mentioned above, the present invention may be embodied in any number of display devices. For this reason, only the elements of the display device relevant to the invention are being illustrated and discussed herein. Other elements—for instance, the image capture and storage mechanisms in video and digital still cameras—are omitted so as not to obscure the invention. The image generating arrangement 22 is used to create an image that, in near-eye mode, is relayed by optics onto the retina of the eye, and that in projection mode, is magnified so as to be displayed on an internal or external display screen, where it can be viewed by one or more persons. The image created in near-eye mode is a virtual image, while the image created in projection mode is a real image of the image generating arrangement.

The image generating arrangement 22 may be, for example, a liquid crystal microdisplay, such as disclosed in U.S. Pat. Nos. 5,748,164 and 5,808,800, which patents are incorporated herein by reference. Such liquid crystal microdisplays include, for example, ferroelectric, nematic, and antiferroelectric liquid crystal materials. Because it is well known in the art of liquid crystal microdisplays how to create useful products using such devices, the various optical components, such as polarizers, analyzers, and light sources, that are necessary to make these devices function properly, will not be described in detail herein. In addition to liquid crystal microdisplays, other suitable devices could include miniature transmissive liquid crystal on silicon devices where the silicon is either single crystal silicon of the type disclosed by Kopin Corp., polysilicon devices in manufacture from many sources, or TFT devices. Emissive display types such as miniature CRTs (cathode ray tubes), FEDs (field effect devices), or OLEDs (organic light emitting diodes) also could be used. The present invention also could include a micromechanical device such as the digital micromirror devices (DMD) manufactured by Texas Instruments. Generally, microdisplays may have a diagonal dimension that is less than 5 centimeters, and preferably less than 2.5 centimeters, however larger microdisplays are possible. For example, the assignee of the present invention currently sells microdisplays having a diagonal dimension of approximately 1 centimeter and microdisplays having a diagonal dimension of approximately 2.2 centimeters. Because the present invention is not dependent on the specific type of image generating device used, any image device small enough to fit within the display device and able to produce an image capable of being both magnified and projected is considered to be within the scope of the present invention. The term image generating arrangement will be used throughout to designate all such displays.

Display device 20 also includes a movable mirror assembly 24 located adjacent to the image generating arrangement 22. A first lens arrangement 26 and a near-eye port 28 are associated with a near-eye mode, while a second lens arrangement 30, a fold mirror 32, and a projection screen 34 are associated with a projection display mode. Numerous transmissive screen materials are available to choose from for the projection screen. The screen may be made of, for example, ground glass, a bulk diffusing material, a black matrix type beaded screen or others. In FIG. 1, the device 20 is in the near-eye mode, in which the mirror assembly 24 is in a position to allow light from the image generating arrangement 22 to pass directly to the near-eye port 28 via the first lens arrangement 26. In FIG. 2, the mirror assembly 24 has been moved or deployed to a position to reflect the light from the image generating arrangement 22 toward the second lens arrangement 30 and the fold mirror 32 for relay to the projection screen 34. As will become clear hereinafter, the location of the projection screen is not constrained to the location shown in FIGS. 1 and 2 or any particular surface relative to the near-eye port 28.

The movement of the mirror assembly 24 may be controlled in any number of ways. For example, a mode-selection switch 36 having two or more positions may be used to select among near-eye, projection, both near-eye and projection, and no image modes. As an alternative to the mode-selection switch 36, a proximity detection arrangement 37 could be used to engage the near-eye mode when it senses that a user is attempting to view an image through the near-eye port.

In order for the display device 20 to display images in both the near-eye and projection modes simultaneously, the mirror assembly 24 may include a partially-silvered surface that, in the position shown in FIG. 2, allows the image to remain visible via the near-eye port 28, while simultaneously reflecting the image to the projection screen 34. By careful selection of the construction of the partially-silvered mirror, a balance between the intensity of the near-eye image and the projection image could be achieved. Of course, the partially-silvered mirror could be replaced with any other suitable means that would allow a significant portion of the light to be transmitted while a significant portion of the light is reflected.

The display device 20 also includes an intensity control arrangement 38, that determines the intensity of the image produced by the image generating arrangement 22. By varying the intensity of the image, the display device 20 may display at a lower intensity in the near-eye mode, thus saving electrical power and allowing for longer operation if the device is powered by a finite source, such as a battery. Methods for varying the intensity could include varying the output of the light source, in the case of transmissive or reflective image generating arrangements, or the output of the display elements in the case of emissive devices. Another method for varying the intensity of the image would be to include additional light sources to be used only in certain modes. Other suitable means for accomplishing intensity variation are also possible and should be considered within the scope of the present invention.

The magnification required for the optical path in the projection display mode is a consequence of the projection screen size and the size of the image generating arrangement 22, and is thus a matter of design choice, but a magnification factor on the order of 10 would not be unusual. However, the design magnification factor may vary substantially from this number based on many specific design considerations. The choice of lenses and other devices is a consequence of this and of the desired magnification path length

It should also be noted that some projection methods may create an image that is inverted (relative to the directional sense for the near-eye mode) if the direction of scan on the microdisplay is left untouched. While such an image would still be useful, it would be preferable to have the ability to correct this. It is within the capability of many microdisplays and other displays to change the direction of scan electronics both horizontally and vertically. In semiconductor-based displays, the signals used to change the scan direction are sometimes referred to as H_{flip} and V_{flip}. Thus, the present invention includes the ability to control these signals to provide upright images in each mode, based on a mode selection switch or sensor that senses the mode to use based on the user's proximity to the near-eye port, or some other parameter.

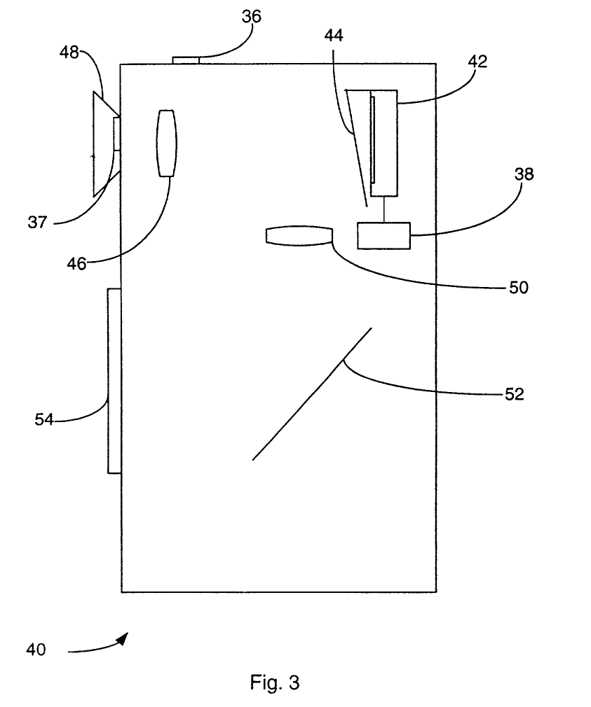

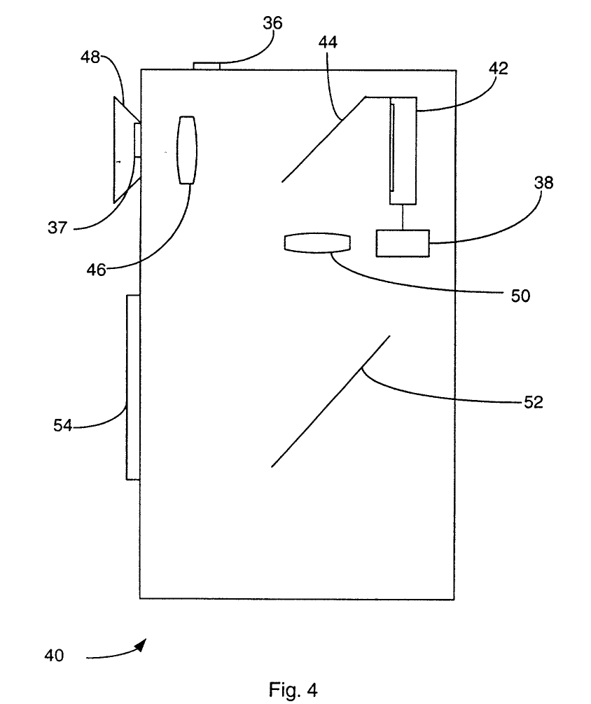

A second embodiment of the present invention is depicted in FIGS. 3 and 4. In this embodiment, a display device 40 includes a image generating arrangement 42. A movable reflective linear polarizer 44 such as a wire grid polarizer is located adjacent to the arrangement 42. A first lens arrangement 46 and a near-eye port 48 are associated with a near-eye mode, while a second lens arrangement 50, a fold mirror 52, and a projection screen 54 are associated with a projection display mode. In FIG. 3, the device 40 is in the near-eye mode, in which the linear polarizer 44 is in a position to allow light from the image generating arrangement 42 to pass directly to the near-eye port 48 via the first lens arrangement 46. In FIG. 4, the linear polarizer 44 has been moved or deployed to a position to reflect the light from the image generating arrangement 42 to the fold mirror 52 for relay to the projection screen 54.

Recent advances in the manufacture of wire grid polarizers have yielded devices suitable for use in reflection as well as in transmission. Other types of reflective polarizers deployed as flat devices are known in the art and may be used. FIG. 3 portrays an operating mode in which the light from the image generating arrangement 42 is analyzed in transmission by the linear polarizer 44 to create an image for display at the near-eye port 48, while FIG. 4 portrays the operating mode in which the linear polarizer 44 is moved to analyze light from the image generating arrangement 42 in reflection for display at the projection screen 54. Because the polarization of the reflected light is orthogonal to the polarization of the transmitted light, one image would be the complement of the other.

This disability could be overcome quite simply if the image generating arrangement 42 is a ferroelectric liquid crystal device. It is well known to those experienced in the art that the LEDs used to illuminate such devices can be operated at a 50% duty factor so that the image can be DC balanced during the dark periods. It is only necessary to reverse the timing of the ON periods and OFF periods to achieve a positive image in both instances. Thus, in response to the mode selected or a sensor for determining the mode, this timing can be reversed or not reversed so as to achieve a positive image for either the transmitted or the reflected image, as desired.

If the image generating arrangement 42 is one of a variety of imaging devices that produces an unpolarized image such as an FED, OLED, DMD, or CRT, then it would be possible to use a display device 40 such as that shown in FIG. 4 to show images simultaneously at both the near-eye port and on the projection screen. If the screen is suitably located, then a group of viewers can view a projected image while an individual simultaneously views a magnified version of the same image. It would be possible to replace the wire grid polarizer in such an embodiment with a partially-silvered mirror, as explained previously with respect to FIGS. 1 and 2.

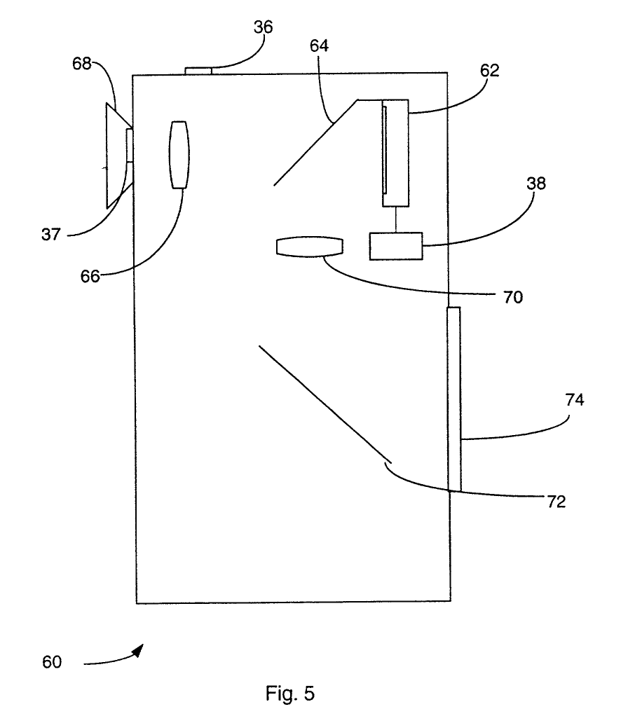

A third embodiment of the present invention is depicted in FIG. 5. In this embodiment, an alternative projection path is demonstrated for a device 60 which includes an image generating arrangement 62. A movable reflective device 64 such as a wire grid polarizer or a mirror, is located adjacent to the arrangement 62. A first lens arrangement 66 and a near-eye port 68 are associated with a near-eye mode, while a second lens arrangement 70, a fold mirror 72, and a projection screen 74 are associated with a projection display mode. As can be appreciated, the projection screen 74 is in no way constrained to be on the same surface or on the same plane as the near-eye port 68. Instead, the projection screen 74 and/or the near-eye port 68 can be located on any surface through the use of suitable fold mirrors and/or conventional optical components.

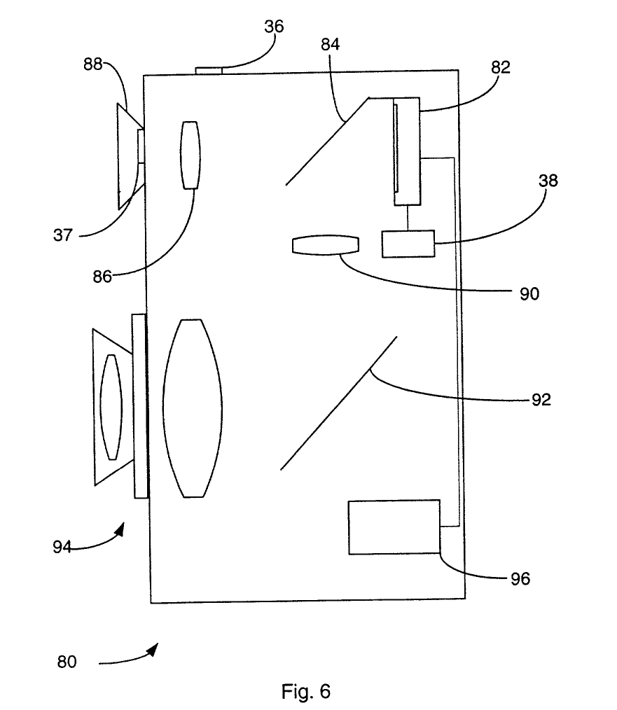

A fourth embodiment of the present invention is depicted in FIG. 6. This embodiment includes a device 80 with an image generating arrangement 82. A movable mirror assembly 84 is located adjacent to the arrangement 82. A first lens arrangement 86 and a near-eye port 88 are associated with a near-eye mode, while a second lens arrangement 90, a fold mirror 92, and a projection optics arrangement 94 are associated with a projection display mode. In FIG. 6, the mirror assembly 84 has been moved or deployed to a position to reflect the light from the image generating arrangement 82 to the fold mirror 92 for relay to the projection optics arrangement 94. As can be appreciated, this embodiment does not show a projection screen as an integral part of the device 80. Instead, the projection screen may be any suitable surface external to the device 80, such as a piece of paper, a mouse pad, a wall, a door, a convenience tray on a commercial aircraft or the like. Although not required, for most applications a white surface would likely be desirable as a projection surface. In this manner, an image can be projected out from the device 80 onto any suitable surface. It may or may not be desirable to provide the ability to focus the image when it is desired to project an image to any of a variety of surfaces at a variety of distances from the device 80. If so, there may be included a conventional auto-focus system, or some other means of adjusting or selecting the focus of the image.

The display device 80 also may include an image distortion compensation arrangement 96 that may be used to electronically “pre-distort” the image produced by image generating arrangement 82. For instance, if the plane of the projection screen is not parallel to the plane of the image generating arrangement, the projected image may have a “keystone” shape. The image distortion compensation arrangement can cause the image generating arrangement to produce an image that is distorted in the opposite direction so that the projected image displays correctly.

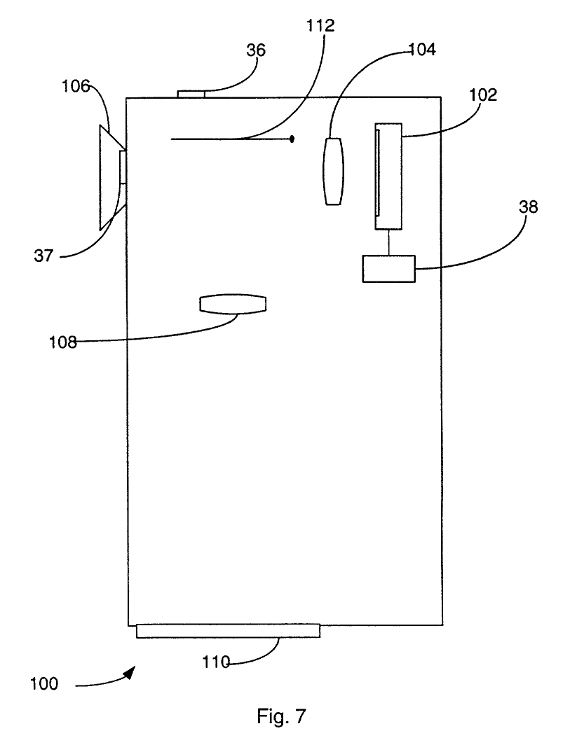

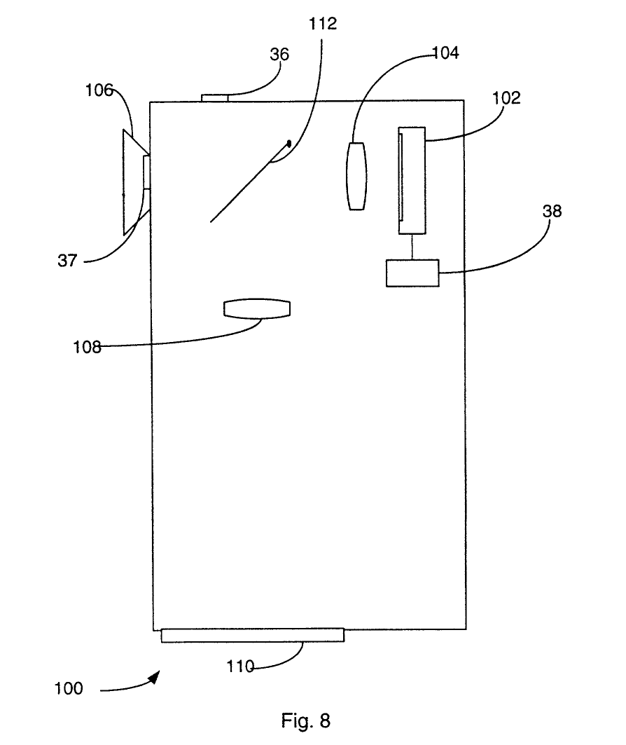

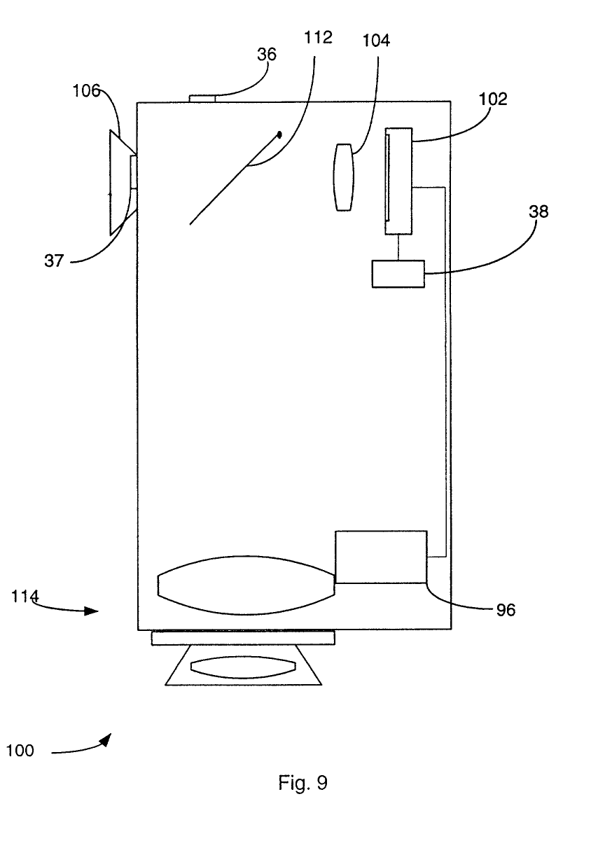

FIGS. 7 and 8 depict a fifth embodiment of the present invention wherein the near-eye and projection modes share one optical element. FIGS. 7 and 8 illustrate a display system 100, including an image generating arrangement 102, a first lens arrangement 104, a near-eye port 106, a second lens arrangement 108, a projection screen 110, and a moveable mirror assembly 112. Images from the arrangement 102 travel through the first lens arrangement 104 in both the near-eye and projection modes. In FIG. 7, the moveable mirror assembly 112 is position for the near-eye mode, while in FIG. 8, the moveable mirror assembly 112 is positioned for projection mode. It also would be possible to adapt this embodiment of the present invention as shown in FIG. 9 for projecting images to an external screen by including a projection optics arrangement 114. Such modifications should now be obvious in light of the preceding disclosure with respect to FIG. 6. Of course it is also possible to operate the display device 100 in both projection and near-eye modes simultaneously by including a partially-silvered surface on the mirror 112 or through other means as previously described.

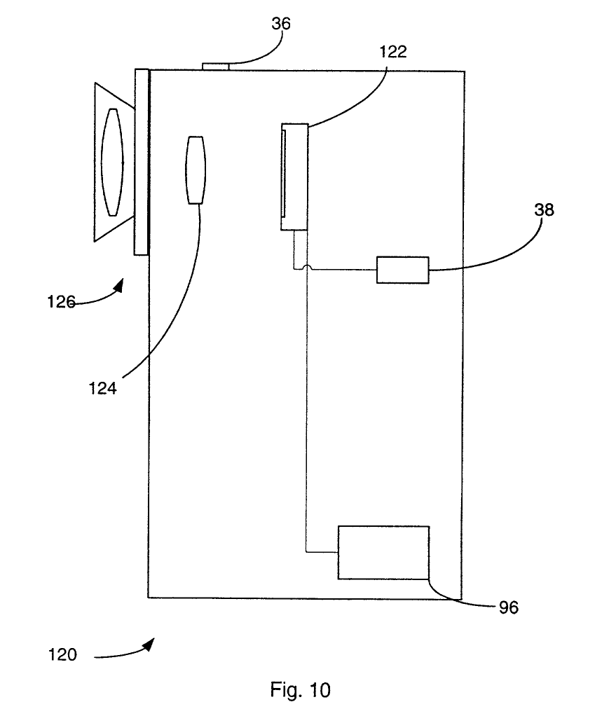

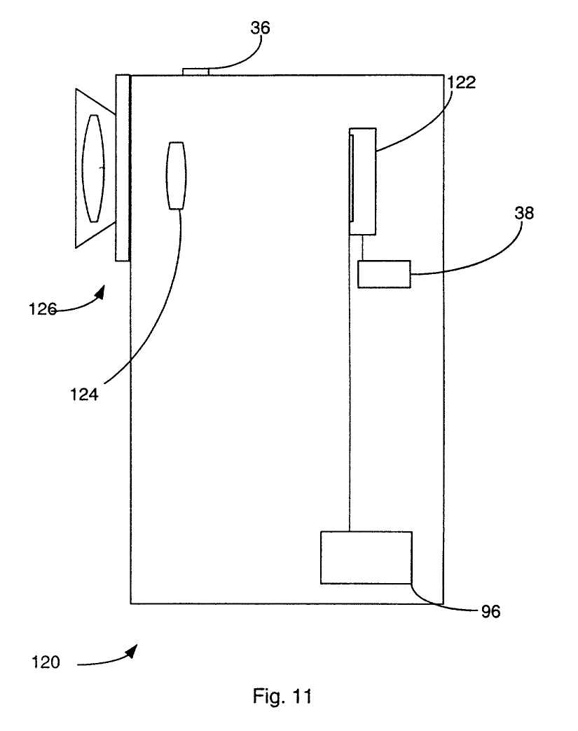

FIGS. 10 and 11 depict a sixth embodiment of the present invention wherein the image generating arrangement is moveable relative to the optics arrangements, depending on the mode selected. FIGS. 10 and 11 illustrate a display device 120, including an image generating arrangement 122, a lens arrangement 124, and a combined near-eye and projection optics assembly 126. FIG. 10 illustrates the position of the image generating arrangement 122 for near-eye mode, while FIG. 11 illustrates its position for projection mode. In this embodiment, images are projected to an external surface.

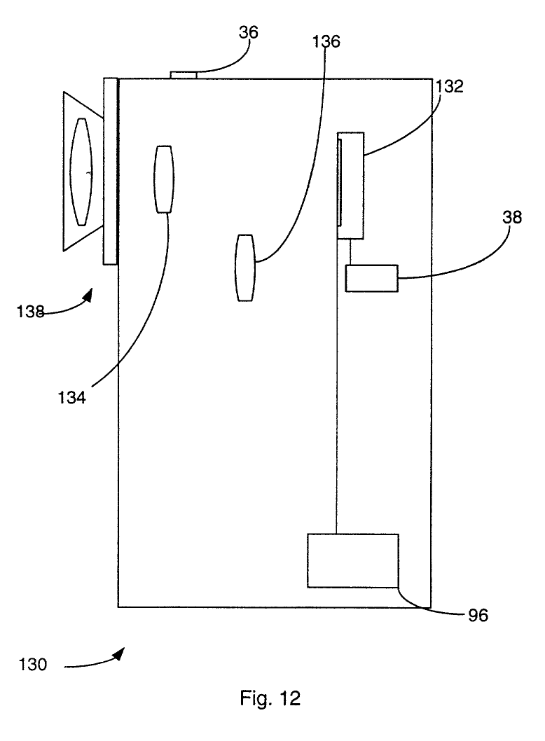

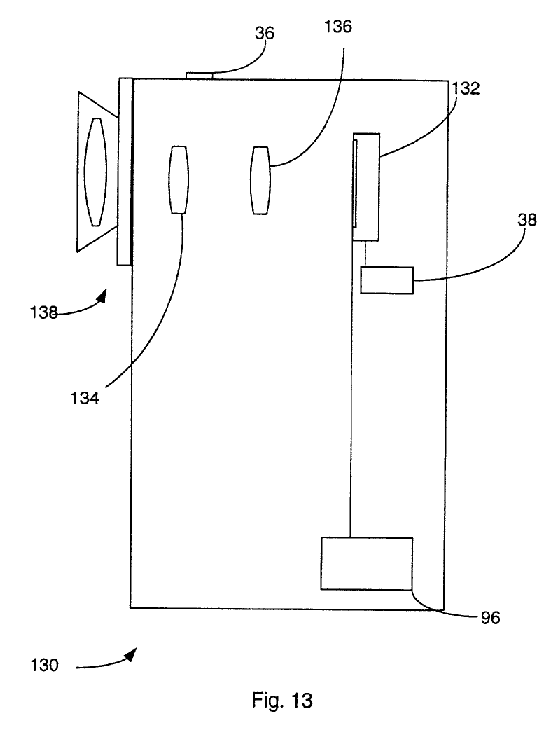

FIGS. 12 and 13 depict a seventh embodiment of the present invention wherein an optical element moves in and out of the optical path, depending upon which mode is selected. FIGS. 12 and 13 illustrate a display device 130, including an image generating arrangement 132, a first lens arrangement 134, a second lens arrangement 136, and a combined near-eye and projection optics assembly 138. The second lens arrangement 136 is selectively positioned either in or out of the optical path, depending on whether the near-eye or the projection mode is selected. FIG. 12 illustrates the position of the second lens arrangement 136 for near-eye mode, while FIG. 13 illustrates its position for projection mode. In this embodiment, images are projected to an external surface. Alternatively, a moveable part could contain or be linked to two different lens arrangements, either one of which could be moved into the optical path depending on the mode to be employed.

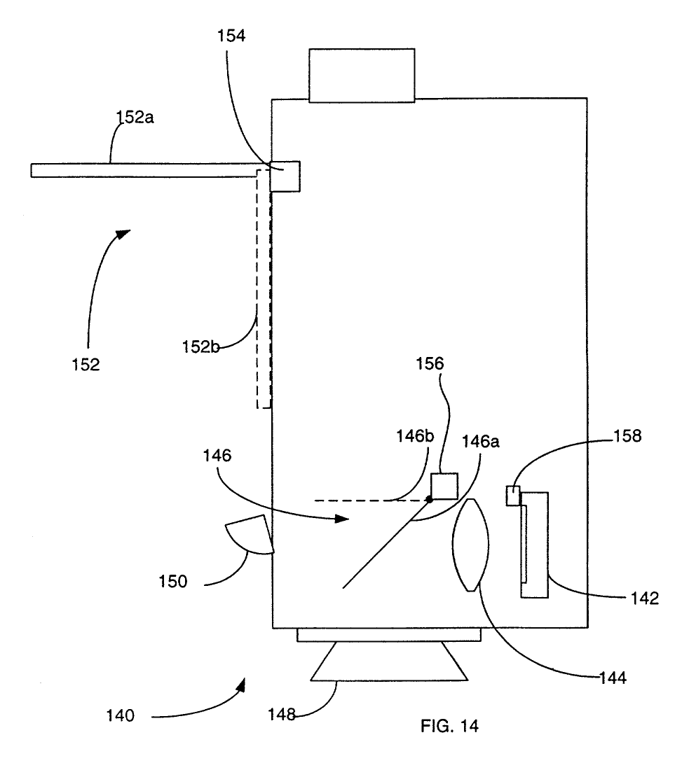

FIG. 14 depicts an eighth embodiment of the present invention with a display device 140, including an image generating arrangement 142, a first lens arrangement 144, a moveable mirror arrangement 146, a near-eye port 148, a projection optics arrangement 150, and a moveable projection screen 152. As in previous embodiments, the moveable mirror arrangement 146 may move between the two positions indicated by reference numbers 146a and 146b (shown in phantom) or may remain in the position indicated by reference numeral 146a, in which case the arrangement 146 would allow a portion of the light constituting the images produced by the image generating arrangement 142 to pass to the projection optics arrangement 150. The projection optics arrangement 150 may be, for example, a curved mirror or combination of mirrors. Alternatively, the projection optics arrangement 150 may be a lens or combination of lenses. Alternatively, the projection optics arrangement 150 may be any combination of mirrors, lenses or other optical elements that direct light toward and focus light on the projection screen 152 at the location indicated by reference number 152a. Moveable projection screen 152 may be moveable between the positions indicated by reference numbers 152a and 152b (shown in phantom), position 152a being its position when the projection mode is in use. A switch or other type of sensor 154 may be associated with the projection screen 152, so as to sense information about the position of the projection screen 152 in order to automatically select the projection or the near-eye mode. Similarly, a control device 156 may be associated with the moveable mirror arrangement 146 to move the arrangement to one of the positions 146a or 146b depending on the mode selected, which mode selection may or may not occur based on the sensor 154.

In addition, an imaging sensor 158 (such as a CMOS sensor or other appropriate type of sensor) my be placed at or near the focal plane of the lens 144 adjacent to the image generating arrangement 142 to be able to capture an image of the projection screen 152 when it is in position 152a. In this manner, the position of a pointing device such as a finger or the like can be detected. The position of the pointing device can be used to control the operation of the display device 140 or the device in which it is embedded, such as a camcorder, digital still camera, PDA, or mobile phone. Of course, there are other locations where the imaging sensor 158 could be placed. For example, the optical path from the projection screen 152 to the imaging sensor 158 may be only partially coincidental or not at all coincidental with the optical path from the image generating arrangement 142 to the projection screen 152. The sensor 158 may react to an external change in local brightness or wavelengths of light (such as infrared) not associated with the display system 140 by means of dichroics or bandpass filters.

The projection screen 152 may incorporate any of a number of screen surfaces known to those skilled in the art as being appropriate for the use described herein. Additionally, the projection screen 152 may incorporate a number of useful characteristics. For example, the projection screen 152 may include a polarizing surface that rejects at least a portion of the ambient light, thus making the projected image appear brighter relative to the ambient environment. Additionally, projection screen 152 may include a light-directing arrangement that directs light in a preferred direction. Thus, in the preferred direction, more light is directed than would otherwise be the case, and in certain other directions, less light is directed than would otherwise be the case. Such a non-uniform gain feature enhances the image quality of the projected image. It would also be possible to include these features in other embodiments of the present invention described herein with respect to display devices having attached projection screens.

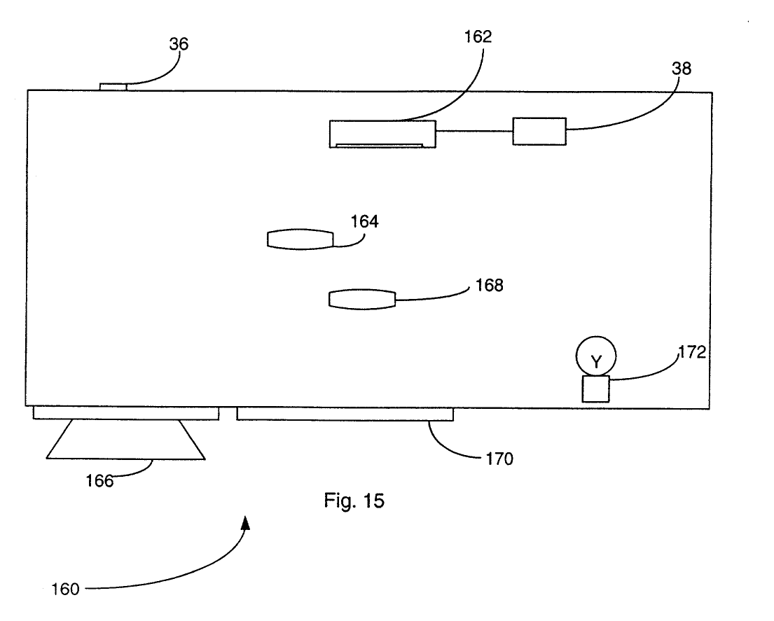

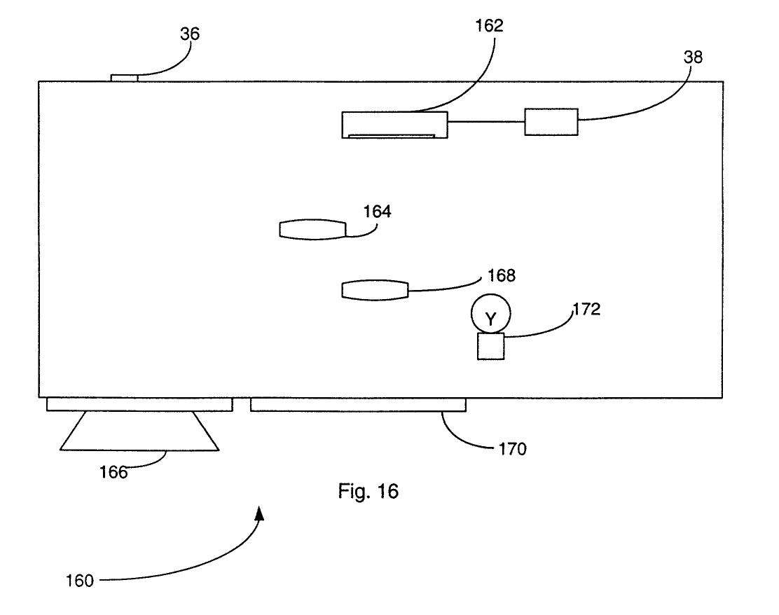

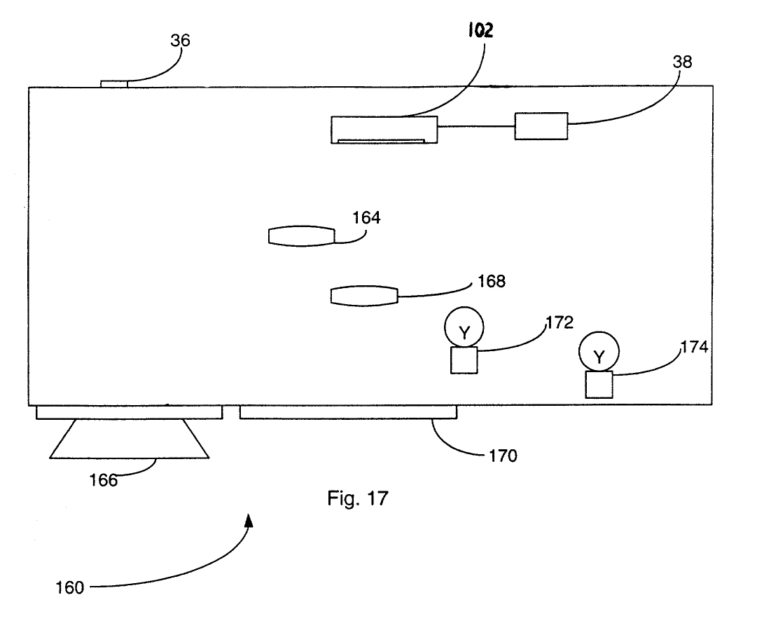

FIGS. 15, 16, and 17 depict a ninth embodiment of the present invention wherein the illumination source or sources are relocated, depending upon which mode is selected. FIGS. 15, 16, and 17 illustrate a display device 160, including an image generating arrangement 162, a first optics arrangement 164, a near-eye port 166, a second optics arrangement 168, a projection screen 170, and a moveable light source 172. The light source 172 is moveable between the locations depicted in FIGS. 15 and 16. In FIG. 15, the light source 172 is positioned for near-eye mode. In FIG. 16, the light source 172 is positioned for projection mode. Alternatively, a second light source 174 may be included as shown in FIG. 17, in which case both the near-eye and projection modes may be active simultaneously or be alternately selected. This arrangement for light source 172 has the additional advantage that the display device 160 may be switched between the near-eye and projection modes by simply turning the appropriate light source on or off and without the need to relocate any components.

The embodiment of the present invention illustrated in FIGS. 15-17 is the first embodiment discussed thus far herein having a light source arrangement separate from the image generating arrangement, while the other image generating arrangements had a light source integrally associated therewith. The light source arrangement in this embodiment is shown in combination with a reflective image generating arrangement; however, this is not a requirement. In light of this disclosure herein, those skilled in the art could readily adapt this embodiment into an arrangement using a transmissive image generating system. Further, the teachings of this embodiment would apply equally to other embodiments discussed herein.

In light of the present discussion of the embodiment of FIGS. 15-17, it should be noted that the present invention may employ a wide variety of useful illumination devices and systems. The most common illumination system currently used for near-eye displays is one comprised of light emitting diodes, or LEDs. The LEDs may be present in one or more colors and the images may be generated sequentially to create color. Alternatively the images may be achromatic (black-and-white) and one or more types of LEDs—combined through the use of, for example, diffusers—to create the achromatic illumination required. Alternatively a miniature white fluorescent lamp similar to those used to illuminate the liquid crystal displays commonly used on notebook computers may be chosen. For achromatic light requirements, the output of the miniature lamp may be filtered. Lasers could also be used. Finally, some type of electroded or electrodeless lamp of the type commonly used for projection displays may alternatively be used. While this may be unlikely for applications where the primary source of power is a battery device, they are imminently practical for tethered applications where a power cord to an external source of power is utilized. Any other suitable source of illumination could also be used.

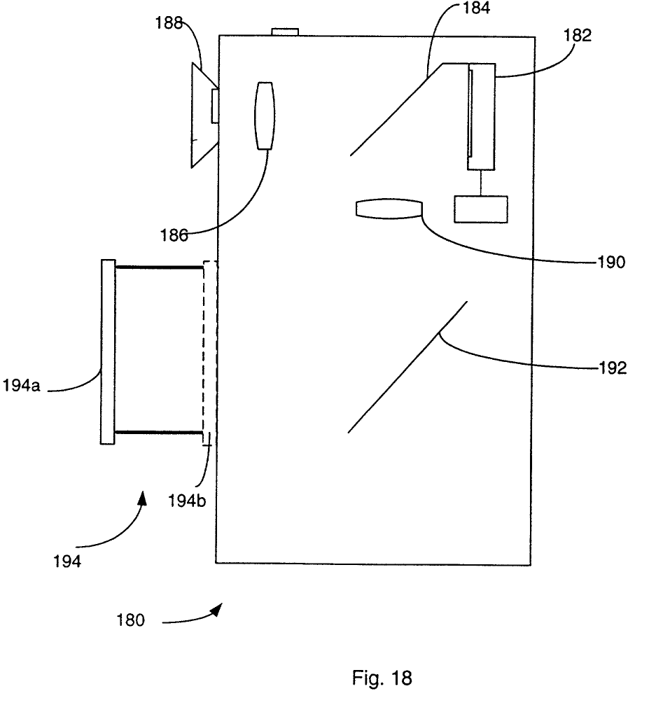

FIG. 18 illustrates a tenth embodiment of the present invention, a display device 180. The display device 180 includes an image generating arrangement 182, a first mirror 184, a first optics arrangement 186, a near-eye port 188, a second optics arrangement 190, a second mirror 192, and a projection screen 194. The projection screen 194 is moveable between the positions shown, 194a and 194b (shown in phantom) via flexible housing 196. The projection screen is positioned at location 194a when the projection optical path is operative.

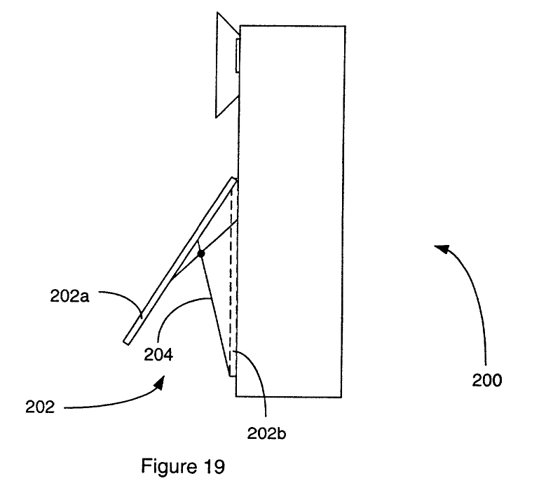

FIG. 19 illustrates an eleventh embodiment of the present invention, display device 200. In this embodiment, internal optical elements are not shown. However, in light of the description presented thus far, it should be apparent to ones skilled in the art how to position such devices. The display device 200 includes projection screen 202, which is operable between two positions indicated by reference numbers 202a and 202b (shown in phantom) via expansion mechanism 204. The projection screen 202 is positioned at the location indicated by reference number 202a when the projection optical path is operative.

The embodiments presented in FIGS. 14, 18, and 19 illustrate an important aspect of the present invention. It is now possible for display devices of the variety discussed herein to include a projection screen integral to the device, yet still produce a projected image that follows an optical path external to the device footprint. This is important in overcoming the limitation created by the volume of the display device if the optical path is completely contained within the device. By allowing the optical path to travel outside the display device, larger images are possible in combination with miniature display devices having integral projection screens.

In order to provide a highly advantageous dual-mode display system, a highly efficient illumination system is desirable. The display illuminator should be designed to produce a uniformly bright image on the screen, while at the same time retaining a high degree of optical efficiency. This problem is well known in the projection art, and has a variety of solution forms including diffuse illumination, critical illumination and Köhler illumination, as taught, for example, by Malacara in Geometrical and instrumental optics (Academic Press, San Diego, 1988), which is incorporated by reference herein.

When the display panel used requires polarized light, improved efficiency with LED illumination may be had using polarization recovery techniques such as those originally developed for arc lamps, such as taught by Itoh, et al. in “Ultra-high-efficiency LC projector using a polarized light illuminating system,” SID International Symposium Digest of Technical Papers (Society for Information Display, Santa Ana, Calif., 1997) pp. 993-996, which is incorporated by reference herein.

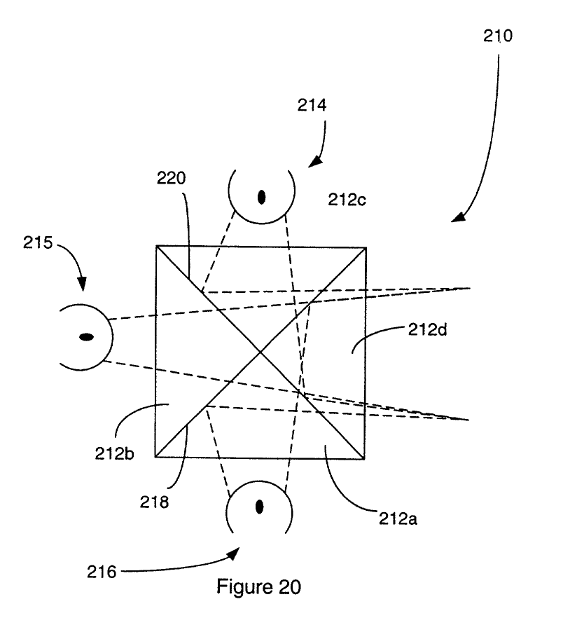

FIG. 20 illustrates one example of an illumination system 210 that may be incorporated into the present invention. Illumination system 210 includes an assembly of four prisms 212a-212d in a configuration known in the art as an “X-cube”. The prisms are arranged as shown into a cube. Light sources such as a red LED 214, a green LED 215, and a blue LED 216 are positioned as shown at three of the four cube faces. Each diagonal cross-section of the cube, each including a face of two prisms, first diagonal cross-section 218 and second diagonal cross-section 220, are treated so as to reflect light of certain wavelengths and transmit light of other wavelengths. In this case, first diagonal cross-section 218 is treated to reflect blue light and second diagonal cross-section 220 is treated to reflect red light. Thus, white light is emitted from the fourth face of the x-cube. This arrangement has the advantage of producing combined light without additional optical elements such as diffusers that reduce the efficiency of the illumination system. Alternatively, other devices for combining colors from separate light sources to create white light could be used, such as dispersive color combiners, diffraction gratings, and diffusers.

As can be appreciated the present invention can provide two separate images of a single image generating arrangement, such as a microdisplay. These images may exist simultaneously or they may only exist mutually exclusively. Two different magnifications and image conditions are created. One image is virtual, viewable through an infinity focus objective for near eye use. The other image is real, created by a conjugate optical system that projects the magnified image onto an image display screen. The image display screen may be viewed from a distance and from multiple observation locations.

The foregoing description is considered as illustrative only of the principles of the present invention. Furthermore, since numerous modification and changes will occur readily to those skilled in the art, it is not desired to limit the invention to the exact construction and process shown and described above. For example, the present invention is not limited to image capture devices that display only images captured by the particular device. In fact, the present invention even is not limited to image capture devices. It may be desirable to display images transmitted to other devices, such as PDAs and cellular telephone phones. Consider, for example, an internet-enabled cellular telephone, used by someone on a plane to access an image over the internet wherein the individual shares the image with the person sitting next to him by projecting it onto the convenience tray. Also, in image capture devices such as digital still cameras and camcorders, the image displayed may be a real-time image or an image that has already been captured and stored. Additionally, the invention is not limited to the particular examples and arrangements of optical elements illustrated and described herein. For instance, the fold mirrors in the figures of this application show the fold mirrors as parallel to one another. This is not a requirement, however. In addition, the number of fold mirrors (including the wire grid polarizer or the partially-silvered mirror) can vary from one to as many as necessary based on the overall design. Accordingly, all suitable modifications and equivalents may be regarded as falling within the scope of the invention as defined by the claims that follow.

What is claimed is:

1. A display device, comprising:
an image-generating arrangement configured to reproduce images, the images being visible to a viewer when the device is operated in either or both of two modes, including a first mode wherein the device produces a real image of the image-generating arrangement, and a mode wherein the device produces a virtual image of the image-generating arrangement.

2. A display device as defined in claim 1, wherein the image-generating arrangement is a microdisplay.

3. A display device as defined in claim 2, wherein the microdisplay is a liquid crystal microdisplay.

4. A display device as defined in claim 3, wherein the liquid crystal microdisplay is a ferroelectric liquid crystal microdisplay.

5. A display device as defined in claim 3, wherein the liquid crystal microdisplay is a nematic liquid crystal microdisplay.

6. A display device as defined in claim 2, wherein the microdisplay is a digital micromirror device.

7. A display device as defined in claim 2, wherein the microdisplay is a TFT device.

8. A display device as defined in claim 2, wherein the microdisplay is an OLED device.

9. A display device as defined in claim 1, further comprising one or more light source arrangements external to the image-generating arrangement that emit light and cooperate with the image-generating arrangement to produce the images during either or both of the modes.

10. A display device as defined in claim 9, wherein at least one of the one or more light source arrangements includes each of a red, a green, and a blue LED.

11. A display device as defined in claim 9, wherein the device includes one and only one light source arrangement.

12. A display device as defined in claim 9, wherein the device includes at least two light source arrangements.

13. A display device as defined in claim 9, further comprising a light source drive arrangement that establishes the intensity of the light from the one or more light source arrangements.

14. A display device as defined in claim 13, wherein the intensity of the light established by the light source drive arrangement relates to the image-review mode in which the display device is being operated.

15. A display device as defined in claim 1, further comprising a mode-selection arrangement that establishes the modes in which the display device is being operated.

16. A display device as defined in claim 15, wherein the mode-selection arrangement includes a switch having at least two positions that allows an operator of the device to select the desired image-review mode.

17. A display device as defined in claim 15, further comprising an eyepiece in which an operator of the device can look to view the virtual image of the image-generating arrangement when the device is operated in the second mode.

18. A display device as defined in claim 17, wherein the mode-selection arrangement includes a proximity sensor that senses when the operator of the device is looking into the viewfinder.

19. A display device as defined in claim 15, further comprising an image screen upon which the real image of the image-generating arrangement appears when the device is operated in the first mode.

20. A display device as defined in claim 19, wherein the image screen is moveable between at least two positions, an active position for use when the first mode is in operation, and an inactive position for use when the first mode is not in operation.

21. A display device as defined in claim 20, wherein the mode selection arrangement senses the position of the image screen and accordingly establishes the mode in which the device is operated.

22. A display device as defined in claim 19, further comprising a sensing arrangement that determines the position of a pointing device in relation to the image screen.

23. A display device as defined in claim 19, wherein the image screen is polarized to reject at least a portion of the ambient light present in the device's operating environment.

24. A display device as defined in claim 19, wherein the image screen has non-unity gain.

25. A display device as defined in claim 1, wherein the virtual image follows a first optical path to a virtual image location and the real image follows a second optical path to a real image location.

26. A display device as defined in claim 25, wherein the first optical path and the second optical path are nowhere coincident.

27. A display device as defined in claim 25, wherein the first and the second optical paths are substantially coincident.

28. A display device as defined in claim 25, wherein the first and second optical paths are only partially coincident.

29. A display device as defined in claim 25, wherein at least a portion of the second optical path is external to the display device.

30. A display device as defined in claim 1, wherein the real image is formed external to the display device.

31. A display device as defined in claim 1, wherein the display device is a digital still camera.

32. A display device as defined in claim 1, wherein the display device is a video camera.

33. A display device as defined in claim 1, wherein the display device is a portable telecommunication device configured to receive images electronically from an external source.

34. A display device as defined in claim 1, wherein the display device is a personal digital assistant configured to receive images electronically from an external source.

35. A device for producing images, the device comprising:
an illumination arrangement;
a reflective spatial light modulator in optical communication with the illumination arrangement, the SLM configured to modulate the light from the illumination arrangement so as to produce images;
a first lens arrangement that focuses images produced by the SLM such that the focused image appears at a first viewing area, the viewing area being the position of a viewer's retina when the device is operated in a first mode; and
a second lens arrangement that projects images produced by the SLM such that the projected images appear at a second viewing area when the device is operated in a second mode, the second viewing area being visible by more than one viewer.

36. In a device for producing images, the device including an image generating arrangement configured such that multiple viewers can simultaneously view the images produced by the device, the improvement comprising:
an arrangement that creates a second image of the image generating arrangement that allows viewing essentially by only one viewer at a time.

37. A display device embedded in an image capture device, comprising:
a housing containing the image capture device;
a microdisplay located in the housing;
a light source located in the housing;
a first optical path from the light source to a viewing location; and
a second optical path from the light source to a projected image location;
wherein either the first or the second optical path can be selected.

38. A display device embedded in an image capture device that captures images, the display device comprising:
a microdisplay;
a first optical arrangement that provides a viewable image of the microdisplay at a near-eye viewing location; and
a second optical arrangement that provides a projected image at a projected image location;
wherein either the first optical arrangement or the second optical arrangement can be selected.

39. A method of displaying images captured by an image capture device, comprising:
providing a microdisplay;
providing an optical path from the microdisplay to a viewing area where an image of the microdisplay can be viewed; and
providing an optical path from the microdisplay to a projected image location.
